(19) United States
(12) Patent Application Publication
(10) Pub. No.: US 2021/0154953 A1
(43) Pub. Date: May 27, 2021

(54) MOLD FOR RESIN IMPREGNATION MOLDING

(71) Applicant: TOYOTA JIDOSHA KABUSHIKI KAISHA, Aichi-ken (JP)

(72) Inventor: Osamu SAWAI, Okazaki-shi (JP)

(21) Appl. No.: 16/989,903

(22) Filed: Aug. 11, 2020

(30) Foreign Application Priority Data
Nov. 27, 2019 (JP) 2019-214694

(51) Int. Cl. B29C 70/44; B29C 70/54; B29C 70/14

(52) U.S. Cl. CPC B29C 70/443; B29K 2105/14; B29C 70/14; B29C 70/54

(57) ABSTRACT

A mold for resin impregnation molding includes an accommodating portion which is able to accommodate a container body around which a fiber bundle is wound, a storage portion which is able to store an uncured resin having fluidity, a flow path which causes the resin to flow from the storage portion to the accommodating portion, and a pressure control unit which controls a pressure which causes the resin stored in the storage portion to flow through the flow path to the accommodating portion.

### CROSS-REFERENCE TO RELATED APPLICATION

This application claims priority to Japanese Patent Application No. 2019-214694 filed on Nov. 27, 2019, incorporated herein by reference in its entirety.

### BACKGROUND

### 1. Technical Field

The present disclosure relates to a mold for resin impregnation molding.

### 2. Description of Related Art

A method of manufacturing a high-pressure tank in which an intermediate product in which a fiber bundle is wound around a liner is disposed in a mold, and a resin is pressure-filled in the mold to impregnate the fiber bundle is conventionally known (for example, refer to Japanese Unexamined Patent Application Publication No. 2019-152310 (JP 2019-152310 A)).

### SUMMARY

However, when a pressure of the resin to be filled is higher than an internal pressure of the liner (a container body), the liner may be deformed by the pressure of the resin. Further, when the pressure of the resin to be filled is smaller than a pressure of the resin necessary for impregnation, there is a possibility that the fiber bundle may have a portion which is not impregnated with the resin.

Therefore, an object of the present disclosure is to obtain a mold for resin impregnation molding which is able to curb deformation of a container body and generation of an unimpregnated fiber bundle during resin impregnation molding of the container body around which the fiber bundle is wound.

In order to achieve the above-described object, a mold for resin impregnation molding according to the first aspect of the present disclosure includes an accommodating portion which is able to accommodate a container body around which a fiber bundle is wound, a storage portion which is able to store an uncured resin having fluidity, a flow path which causes the resin to flow from the storage portion to the accommodating portion, and a pressure control unit which controls a pressure which causes the resin stored in the storage portion to flow through the flow path to the accommodating portion.

According to the disclosure described in the first aspect, the uncured resin having fluidity stored in the storage portion flows into the accommodating portion under a pressure controlled by the pressure control unit. That is, the pressure control unit adjusts the pressure of the resin with which the accommodating portion is filled. Therefore, the pressure of the resin with which the accommodating portion is filled can be easily adjusted to be lower than an internal pressure of the container body and higher than a pressure of the resin necessary for impregnation, and the fiber bundle can be impregnated with the resin while an appropriate pressure is maintained. Thus, it is possible to curb deformation of the container body and generation of the unimpregnated fiber bundle during the resin impregnation molding of the container body around which the fiber bundle is wound.

Also, a mold for resin impregnation molding described in the second aspect is the mold for resin impregnation molding described in the first aspect, the storage portion may be configured to include an upper surface of an elastically deformable film member, and the pressure control unit may be configured with a space which exposes a lower surface of the film member, and a passage which causes inflow of air into the space and outflow of air from the space.

According to the disclosure described in the second aspect, the pressure of the resin with which the accommodating portion is filled is adjusted by elastically deforming the film member up and down by constant pressure control such as the inflow of air into the space and the outflow of air from the space. Therefore, the pressure of the resin with which the accommodating portion is filled can be easily kept constant.

Also, a mold for resin impregnation molding described in the third aspect is the mold for resin impregnation molding described in the first aspect, the storage portion may be configured with an upper surface of a piston and an inner surface of a holding portion which holds the piston so that the piston is able to move up and down, and the pressure control unit may be configured with a space which exposes a lower surface of the piston, and a passage which causes inflow of air into the space and outflow of air from the space.

According to the disclosure described in the third aspect, the pressure of the resin with which the accommodating portion is filled is adjusted by moving the piston up and down by constant pressure control such as the inflow of air into the space and the outflow of air from the space. Therefore, the pressure of the resin with which the accommodating portion is filled can be easily kept constant.

As described above, according to the present disclosure, it is possible to curb deformation of a container body and generation of an unimpregnated fiber bundle during resin impregnation molding of the container body around which the fiber bundle is wound.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a pressure container (a container body around which a fiber bundle is wound) which is accommodated in a mold for resin impregnation molding according to the present embodiment;

FIG. 2 is a plan view showing a lower mold of a mold for resin impregnation molding according to a first embodiment;

FIG. 3 is a front sectional view showing the mold for resin impregnation molding according to the first embodiment;

FIG. 4 is a plan view showing a lower mold of a mold for resin impregnation molding according to a second embodiment;

FIG. 5 is a front sectional view showing the mold for resin impregnation molding according to the second embodiment; and

FIG. 6 is a plan view showing a modified example of the lower mold of the mold for resin impregnation molding according to the second embodiment.

### DETAILED DESCRIPTION OF EMBODIMENTS

Hereinafter, embodiments according to the present disclosure will be described in detail with reference to the drawings. For convenience of explanation, an arrow D appropriately shown in each of the drawings is set as an axial direction of a pressure container 10, and an arrow R is set as a radial direction of the pressure container 10. Further, the pressure container 10 is filled with hydrogen as a fuel, for example, and is mounted in a fuel cell vehicle (not shown) or the like.

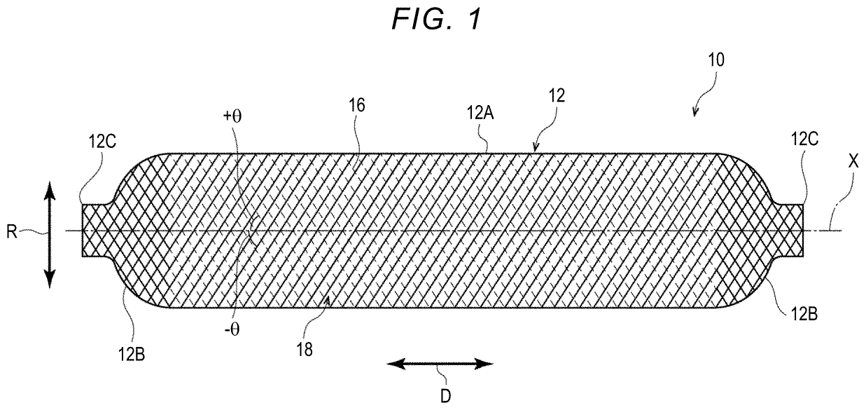

As shown in FIG. 1, the pressure container 10 has a container body 12 called a liner. As an example, the container body 12 is formed of a liquid crystal resin material having an excellent gas barrier property and excellent dimensional stability and includes a cylindrical straight body portion 12A and a substantially hemispherical dome portion 12B integrally formed at both ends of the straight body portion 12A.

Additionally, the pressure container 10 is constituted by winding a tape-shaped fiber bundle 16 having a predetermined width in layers on an outer peripheral surface of the straight body portion 12A and an outer peripheral surface of the dome portion 12B of the container body 12. The fiber bundle 16 is made of a fiber reinforced resin (FRP) containing glass fibers, carbon fibers, aramid fibers, or the like and forms a fiber reinforced resin layer (hereinafter referred to as “reinforcing layer”) 18 on an outer peripheral surface of the container body 12.

Specifically, the fiber bundle 16 is helically wound around the outer peripheral surface of the straight body portion 12A (hereinafter referred to as “helical winding”), and the helically wound fiber bundle 16 forms the reinforcing layer 18.

The helical winding means that the fiber bundle 16 is wound around the entire outer peripheral surface of the straight body portion 12A at a predetermined winding angle +θ with respect to a central axis X of the container body 12 and is then wound from above at a predetermined winding angle −θ with respect to the central axis X of the container body 12 (crossing over the fiber bundle 16 wound at the angle +θ).

That is, the reinforcing layer 18 is configured by winding the fiber bundle 16 in at least two layers on the outer peripheral surface of the straight body portion 12A at the predetermined winding angle +θ and the predetermined winding angle −θ. Although it depends on an internal pressure of the straight body portion 12A, the number of fibers in the fiber bundle 16, and the like, the fiber bundle 16 is actually wound in, for example, about 10 to 20 layers.

On the other hand, the fiber bundle 16 is wound around the outer peripheral surface of the dome portion 12B to be alternately braided (hereinafter referred to as “braiding winding”), and the wound and braided fiber bundles 16 form the reinforcing layer 18.

The braiding winding is winding in which the fiber bundle 16 is wound to be alternately braided as described above, but here, this means that the fiber bundle 16 is wound at the predetermined winding angle +θ and the predetermined winding angle −θ with respect to the central axis X of the container body 12.

In other words, in both the helical winding and the braiding winding, the fiber bundle 16 is wound at the same winding angle θ, and the winding angle θ is within a range of θ=54.7°±10°, preferably within a range of θ=54.7°±5°, and more preferably within a range of θ=54.7°±1°, including a tolerance.

The winding angle θ is an angle derived from a stress (a stress in an axial direction and a stress in a circumferential direction) in the straight body portion 12A when a predetermined internal pressure is applied, and is an angle resulting from the stress in the circumferential direction being twice as large as the stress in the axial direction. That is, although a detailed calculation formula will be omitted, when the winding angle θ according to the stress is calculated by Netting theory, tan² θ=2, and thus θ=54.7° (an equilibrium angle) is derived.

Here, since the dome portion 12B has a smaller stress than the straight body portion 12A when the internal pressure is applied, a degree of reinforcement may be smaller than that of the straight body portion 12A. Therefore, the braiding winding having a lower strength than the helical winding is adopted in the dome portion 12B, and the helical winding having a higher strength than the braiding winding is adopted in the straight body portion 12A. The fiber bundle 16 is wound around the outer peripheral surface of the container body 12 by a known manufacturing apparatus.

In addition, the dome portion 12B includes cylindrical portions 12C which protrude outward in the axial direction of the central axis X of the container body 12 at the axial center thereof. As an example, a sealing plug (not shown) is fitted to one cylindrical portion 12C, a base plug (not shown) is fitted to the other cylindrical portion 12C, and a valve (not shown) is mounted in the base plug.

The pressure container 10 (the container body 12 around which the fiber bundle 16 is wound) as described above is accommodated in an accommodating portion 22 of molds 20 and 21 for resin impregnation molding (hereinafter, simply referred to as “molds”) that will be described below with a radial direction being a vertical direction. Additionally, the fiber bundle 16 (the reinforcing layer 18) is impregnated with an uncured thermosetting resin having fluidity (for example, a resin in which an epoxy resin and a curing agent are mixed: hereinafter, simply referred to as “resin”). Therefore, next, the molds 20 and 21 will be described.

### First Embodiment

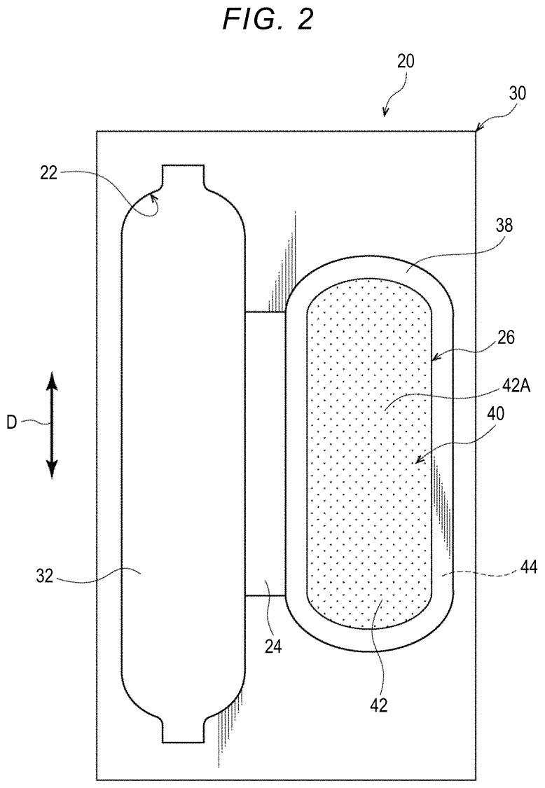

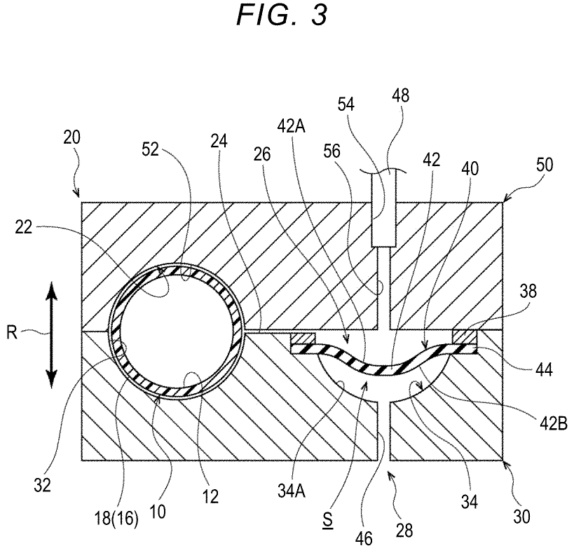

First, the mold 20 according to the first embodiment will be described. As shown in FIGS. 2 and 3, the mold 20 has a lower mold 30 and an upper mold 50. The lower mold 30 includes a lower accommodating portion 32 which accommodates a lower half of the accommodating portion 22, a storage portion 26 which is capable of storing a resin, a flow path 24 which causes the resin to flow from the storage portion 26 to the accommodating portion 22, and a pressure control unit 28 for controlling a pressure for causing the resin stored in the storage portion 26 to flow to the accommodating portion 22 through the flow path 24.

The accommodating portion 22 is formed to have substantially the same shape as the pressure container 10, and the lower accommodating portion 32 is formed to have substantially the same shape as the lower half of the pressure container 10 in the radial direction. The flow path 24 is formed in a slit shape of which a longitudinal direction is the axial direction of the pressure container 10. The storage portion 26 includes a substantially elliptical concave portion 34 of which a longitudinal direction is the axial direction of the pressure container 10 in a plan view, and an elastically deformable film member 40 (an upper surface 42A of a main body portion 42 that will be described later) which is provided to close the concave portion 34 from above.

The film member 40 is formed of an elastic body such as silicon rubber to have a substantially elliptical shape which is slightly larger than the concave portion 34 in a plan view, and a peripheral edge portion 44 thereof is mounted in the lower mold 30 by a frame-shaped (annular) holder 38. That is, the peripheral edge portion 44 of the film member 40 is sandwiched between the lower mold 30 and the holder 38 and is fixed to the lower mold 30 together with the holder 38 by fixing means such as screwing.

Accordingly, the main body portion 42 which excludes the peripheral edge portion 44 of the film member 40 is configured to be elastically deformable in the vertical direction in the concave portion 34, and a resin can be stored on an upper surface 42A thereof. That is, the film member 40 is elastically deformed into a curved shape which is convex downward by a weight of the resin and stores the resin, and the concave portion 34 is adapted to allow the elastic deformation of the film member 40 downward. In FIGS. 2 and 3, illustration of the resin is omitted.

Further, as shown in FIG. 3, a bottom surface 34A of the concave portion 34 is formed to have a substantially semi-circular shape (a curved shape which is convex downward) in a front cross-sectional view when seen in the axial direction of the pressure container 10, and a space S which exposes a lower surface 42B of the film member 40 (the main body portion 42) is formed between the bottom surface 34A and the lower surface 42B of the film member 40 (the main body portion 42).

Additionally, a passage 46 which allows inflow of air into the space S and outflow of the air from the space S is formed in the lower mold 30. That is, one through hole or a plurality of through holes constituting the passage 46 are formed in the bottom surface 34A of the concave portion 34 in the axial direction and parallel to the vertical direction. The space S and the passage 46 constitute the pressure control unit 28 in the mold 20.

On the other hand, the upper mold 50 includes an upper accommodating portion 52 which accommodates an upper half of the accommodating portion 22, a mounting portion 54 on which an injection mixing head 48 for supplying the resin to the storage portion 26 is mounted, and a supply path 56 which serves as a path of resin from the mounting portion 54 to the storage portion 26. The injection mixing head 48 is configured to inject and mix, for example, an epoxy resin and a curing agent. The upper accommodating portion 52 is formed in substantially the same shape as the upper half of the pressure container 10 in the radial direction.

The supply path 56 is formed in the vertical direction and is configured so that the resin injected from the injection mixing head 48 mounted on the mounting portion 54 is supplied to the upper surface 42A of the film member 40 (the main body portion 42) also under the force of gravity. Additionally, a pressure of the resin supplied to the upper surface 42A of the film member 40 (main body portion 42) is controlled by the pressure control unit 28 via the film member 40, and the resin is delivered (flows) to the accommodating portion 22 through the flow path 24 at a constant pressure.

Next, an operation of the mold 20 according to the first embodiment configured as described above will be described.

The resin injected from the injection mixing head 48 passes through the supply path 56 and is supplied to the storage portion 26 configured to include the upper surface 42A of the film member 40 (the main body portion 42). Here, the pressure of the resin injected from the injection mixing head 48 is not directly transmitted to the pressure container 10 (the container body 12 around which the fiber bundle 16 is wound). Therefore, in the injection mixing head 48, a required mixing pressure can be easily set, and for example, curing failure due to failure of the epoxy resin and the curing agent to mix can be curbed or prevented.

When the resin is supplied and stored in the storage portion 26 (the upper surface 42A of the film member 40), the pressure of the resin stored in the storage portion 26 is controlled to be constant by the pressure control unit 28. That is, the resin is delivered to the accommodating portion 22 through the flow path 24 by the constant pressure.

As described above, in the mold 20 according to the first embodiment, the pressure control unit 28 adjusts the pressure of the resin with which the accommodating portion 22 is filled to be constant. Thus, the pressure of the resin with which the accommodating portion 22 in which the pressure container 10 (the container body 12 around which the fiber bundle 16 is wound) is accommodated is filled can be easily adjusted to an appropriate pressure which is lower than an internal pressure of the container body 12 and higher than a pressure of the resin necessary for impregnation.

Additionally, the fiber bundle 16 (the reinforcing layer 18) can be impregnated with the resin while the appropriate pressure is maintained. Therefore, it is possible to curb the deformation of the container body 12 and the generation of the unimpregnated fiber bundle during the resin impregnation molding of the pressure container 10 (the container body 12 around which the fiber bundle 16 is wound).

Further, the pressure control unit 28 adjusts the pressure of the resin with which the accommodating portion 22 is filled by elastically deforming the film member 40 in the vertical direction by the constant pressure control such as the inflow of the air into the space S and the outflow of the air from the space S. Therefore, the pressure of the resin with which the accommodating portion 22 is filled can be easily kept constant.

Further, even when more of the resin than necessary is injected from the injection mixing head 48, the resin can be left in the storage portion 26, and thus the pressure of the resin with which the accommodating portion 22 is filled can always be kept constant. In this way, after the fiber bundle 16 (the reinforcing layer 18) is impregnated with the resin, the resin is heated and cured. Accordingly, it is possible to obtain the pressure container 10 which is excellent in corrosion resistance, can be reduced in weight and cost, and can be easily transported and handled.

### Second Embodiment

Next, a mold 21 according to a second embodiment will be described. The same portions as those in the first embodiment are designated by the same reference numerals, and detailed description thereof will be appropriately omitted.

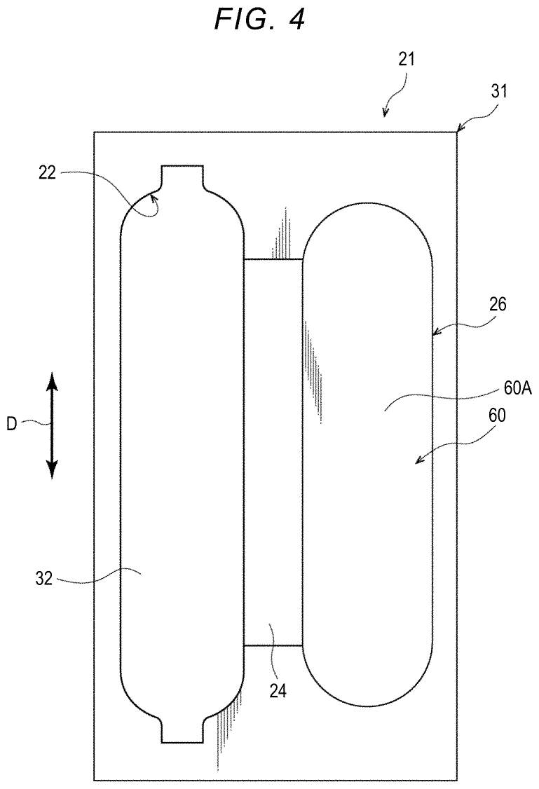

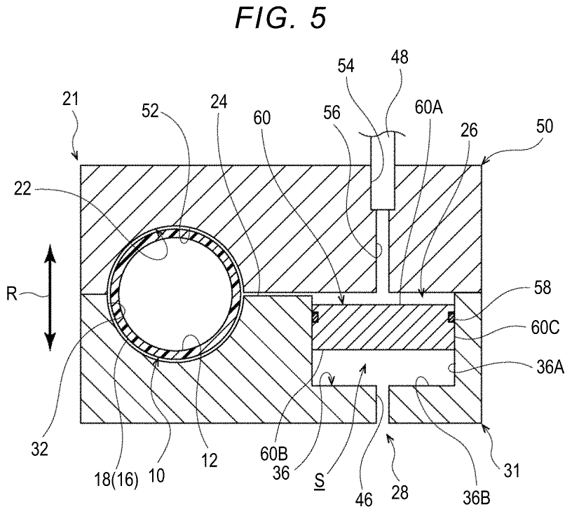

As shown in FIGS. 4 and 5 (the resin is not shown in FIGS. 4 and 5 as well), the mold 21 is different from that of the first embodiment only in that the storage portion 26 is constituted by a piston 60 and a holding portion 36 which holds the piston 60 so that the piston 60 can move up and down, instead of the film member 40.

More specifically, the lower mold 31 has a concave holding portion 36 that holds the piston 60 so that the piston 60 can move up and down, and the holding portion 36 is formed in a substantially elliptical shape in a plan view. The piston 60 is formed to have a substantially elliptical cylinder shape which has substantially the same size as the holding portion 36 in a plan view and has a substantially elliptical shape, and an upper surface 60A of the piston 60 and an inner peripheral surface (an inner surface) 36A of the holding portion 36 constitute the storage portion 26 which stores the resin.

A bottom surface 36B of the holding portion 36 is formed to have a flat shape in a front cross-sectional view when seen in the axial direction of the pressure container 10, and a space S which exposes a lower surface 60B of the piston 60 is defined between the bottom surface 36B and the lower surface 60B of the piston 60. A seal member 58 which prevents the resin stored in the storage portion 26 from leaking to the space S is provided on an outer peripheral surface 60C of the piston 60 over the entire circumference.

Next, an operation of the mold 21 according to the second embodiment configured as described above will be described. The description of the operation common to that of the first embodiment will be appropriately omitted.

The resin injected from the injection mixing head 48 passes through the supply path 56 and is supplied to the storage portion 26 configured by the upper surface 60A of the piston 60 and the inner peripheral surface 36A of the holding portion 36. Then, the pressure of the resin stored in the storage portion 26 is controlled by the pressure control unit 28 to be constant. That is, the resin is delivered to the accommodating portion 22 through the flow path 24 by the constant pressure.

As described above, in the mold 21 according to the second embodiment, the pressure control unit 28 adjusts the pressure of the resin with which the accommodating portion 22 is filled to be constant. Thus, the pressure of the resin with which the accommodating portion 22 in which the pressure container 10 (the container body 12 around which the fiber bundle 16 is wound) is accommodated is filled can be easily adjusted to an appropriate pressure which is lower than an internal pressure of the container body 12 and higher than a pressure of the resin necessary for impregnation.

Additionally, the fiber bundle 16 (the reinforcing layer 18) can be impregnated with the resin while the appropriate pressure is maintained. Therefore, it is possible to curb the deformation of the container body 12 and the generation of the unimpregnated fiber bundle during the resin impregnation molding of the pressure container 10 (the container body 12 around which the fiber bundle 16 is wound).

However, in the case of the mold 21 according to the second embodiment, it is necessary to clean the seal member 58. Additionally, since sliding resistance of the outer peripheral surface 60C of the piston 60 with respect to the inner peripheral surface 36A of the holding portion 36 changes according to a cleaning state of the seal member 58, it is necessary to control the pressure of the resin stored in the storage portion 26 while monitoring the pressure of the resin.

As described above, in the case of the mold 21 according to the second embodiment, although it is necessary to monitor the pressure of the resin stored in the storage portion 26, the pressure control unit 28 adjusts the pressure of the resin with which the accommodating portion 22 is filled by moving the piston 60 up and down by the constant pressure control such as the inflow of the air into the space S and the outflow of the air from the space S. Therefore, the pressure of the resin with which the accommodating portion 22 is filled can be easily kept constant.

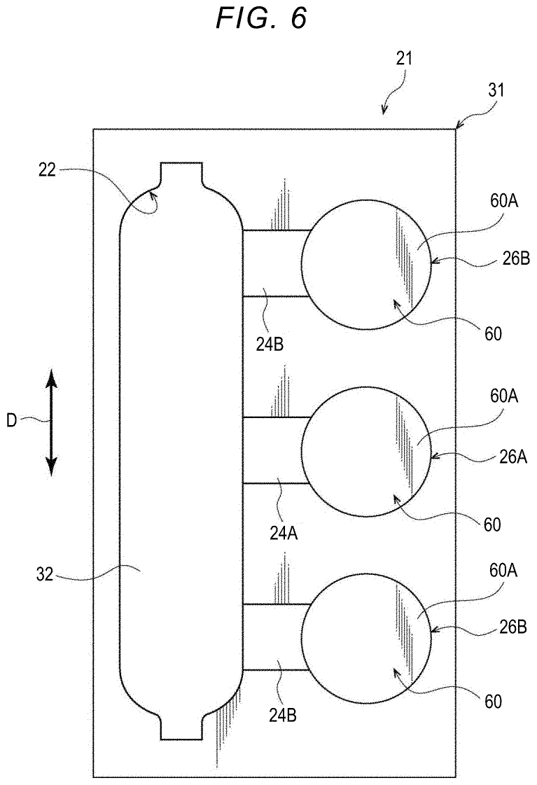

As shown in FIG. 6 (the resin is likewise not shown in FIG. 6), the storage portion 26 and the flow path 24 may be divided into a plurality (three in the drawing) to be provided in the axial direction of the pressure container 10.

That is, a storage portion 26A and a flow path 24A which deliver the resin to the straight body portion 12A of the container body 12, and each of storage portions 26B and each of flow paths 24B which deliver the resin to each of the dome portions 12B of the container body 12 may be provided in the lower mold 31. In this case, a shape of each of the pistons 60 may be, for example, a circular shape in which all three pistons are congruent in a plan view. Further, although not shown, the pressure control unit 28 (the space S and the passage 46) is also provided in each of the storage portions 26.

Even with such a configuration, the pressure of the resin stored in the storage portion 26A and each storage portion 26B (the upper surface 60A of each piston 60) (the pressure of the resin filled in the accommodating portion 22) is controlled (adjusted) by the pressure control unit 28 to be constant. That is, due to the constant pressure, the resin is delivered to the accommodating portion 22 through the flow path 24A and each of the flow paths 24B.

Although the molds 20 and 21 for resin impregnation molding according to the embodiment have been described above with reference to the drawings, the molds 20 and 21 for resin impregnation molding according to the embodiment are not limited to those shown in the drawings and can be appropriately modified in design without departing from the scope of the present disclosure. For example, the container body 12 of the pressure container 10 accommodated in the accommodating portion 22 is not limited to a liquid crystal resin and may be made of another synthetic resin having a gas barrier property, such as high-density polyethylene.

Further, the shape of each of the pistons 60 when the storage portion 26 is divided into a plurality (for example, three) in the axial direction of the pressure container 10 is not limited to the circular shape in a plan view as shown in FIG. 6. The shape of each of the pistons 60 may be, for example, a substantially rectangular shape of which corners are arcuate in a plan view.

What is claimed is:

1. A mold for resin impregnation molding, comprising:
an accommodating portion which is able to accommodate a container body around which a fiber bundle is wound;
a storage portion which is able to store an uncured resin having fluidity;
a flow path which causes the resin to flow from the storage portion to the accommodating portion; and
a pressure control unit which controls a pressure which causes the resin stored in the storage portion to flow through the flow path to the accommodating portion.

2. The mold according to claim 1, wherein:
the storage portion is configured to include an upper surface of an elastically deformable film member, and
the pressure control unit is configured with a space which exposes a lower surface of the film member, and a passage which causes inflow of air into the space and outflow of air from the space.

3. The mold according to claim 1, wherein:
the storage portion is configured with an upper surface of a piston and an inner surface of a holding portion which holds the piston so that the piston is able to move up and down, and
the pressure control unit is configured with a space which exposes a lower surface of the piston, and a passage which causes inflow of air into the space and outflow of air from the space.
